(19) United States
(12) Patent Application Publication
(10) Pub. No.: US 2008/0127180 A1
(43) Pub. Date: May 29, 2008

(54) OPERATING SYSTEM AUTOMATED APPLICATION PORTING TOOL

(76) Inventors: James John Glogowski, Houston, TX (US); Christina Marie Hernandez, Mountain View, CA (US); Loulwa F. Salem, Austin, TX (US); Kimberly DaShawn Simon, Pilugerville, TX (US)

Correspondence Address: IBM CORP (YA);C/O YEE & ASSOCIATES PC, P.O. BOX 802333, DALLAS, TX, 75380, US

(21) Appl. No.: 11/461,224

(22) Filed: Jul. 31, 2006

(51) Int. Cl. G06F 9/445

(52) U.S. Cl. 717/177

(57) ABSTRACT

Computer implemented method, system and computer usable program code for porting an application intended for a first operating system distribution to a second operating system distribution in a data processing system. A computer implemented method for porting an application intended for a first operating system distribution to a second operating system distribution in a data processing system includes identifying a problem when the application is run on the second operating system distribution. A determination is made if a known solution to the identified problem is available. If a known solution to the identified problem is not available, a search is conducted to identify a solution to the problem. At least one modification to the second operating system distribution is created according to the identified solution, wherein the application is enabled to run on the second operating system distribution.

### BACKGROUND OF THE INVENTION

1. Field of the Invention

The present invention relates generally to the data processing field, and more particularly, to a computer implemented method, system and computer usable program code for porting an application intended for a first operating system distribution to a second operating system distribution.

2. Description of the Related Art

Operating system distributions (OS distributions) are different versions of an operating system. A Linux™ distribution, for example, is a common type of distribution, and generally comprises the Linux kernel, GNU operating system (a non-proprietary software system developed by the Free Software Foundation) and other assorted programs. Numerous Linux distributions are available including RedHat, SuSe and Fedora.

A problem that is encountered is that many of the various OS distributions are not compatible such that an application created for one OS distribution cannot be used on other OS distributions. As a result, an application must oftentimes be modified for the various file systems found on different OS distributions. This modifying is currently done by hand resulting in significant costs.

There is, accordingly, a need for a mechanism for porting an application intended for a first OS distribution to a second OS distribution.

### SUMMARY OF THE INVENTION

Exemplary embodiments provide a computer implemented method, system and computer usable program code for porting an application intended for a first operating system distribution to a second operating system distribution in a data processing system. A computer implemented method for porting an application intended for a first operating system distribution to a second operating system distribution in a data processing system includes identifying a problem when the application is run on the second operating system distribution. A determination is made if a known solution to the identified problem is available. If a known solution to the identified problem is not available, a search is conducted to identify a solution to the problem. At least one modification to the second operating system distribution is created according to the identified solution, wherein the application is enabled to run on the second operating system distribution.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 depicts a pictorial representation of a network of data processing systems in which exemplary embodiments may be implemented;

FIG. 2 is a block diagram of a data processing system in which exemplary embodiments may be implemented;

FIG. 3 is a block diagram that schematically illustrates a system for porting an application from a first operating system distribution to a second operating system distribution according to an exemplary embodiment;

FIG. 4 is a diagram that schematically illustrates a global translation table according to an exemplary embodiment; and

FIG. 5 is a flowchart that illustrates a method for porting an application from a first operating system distribution to a second operating system distribution according to an exemplary embodiment.

### DETAILED DESCRIPTION OF THE PREFERRED EMBODIMENT

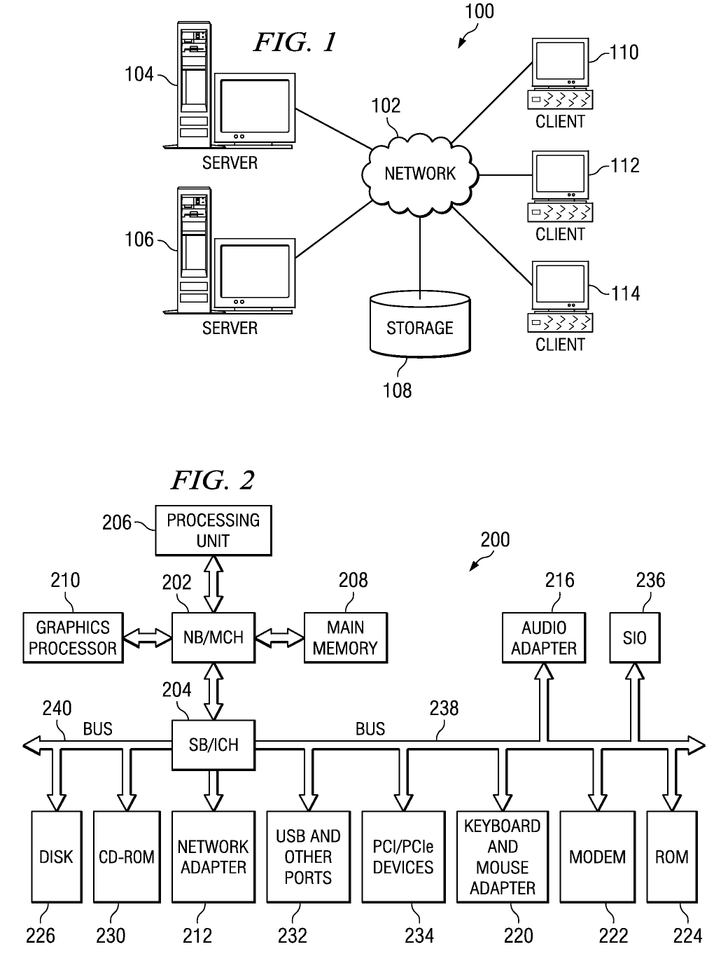

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which exemplary embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which exemplary embodiments may be implemented. Data processing system 200 is an example of a computer, such as server 104 or client 110 in FIG. 1, in which computer usable code or instructions implementing the processes may be located for the exemplary embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both), or a specific distribution such as a specific Linux distribution. An object oriented programming system, such as the Java programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide a mechanism for porting an application intended for a first operating system distribution to a second operating system distribution in a data processing system. More particularly, exemplary embodiments provide a mechanism for automatically porting an application from its originally intended OS distribution to an OS distribution of choice. The mechanism allows a user to point the application to a correct file location in order to run the application on the OS distribution of the user's choice.

According to an exemplary embodiment, a “find” command is used to locate alternate files and prompt a user regarding alternate file locations for a given application. The user is able to choose the file location among the alternate file locations which corresponds most closely to the file on the OS distribution for which the application was originally intended. The mechanism then creates a symbolic link “in between” the correct file location and the expected file location so that the application can run on the new OS distribution. Alternatively, rather than creating a link in between the correct file location and the expected file location, the mechanism may modify the system in other ways to enable the application to run on the second operating system distribution. For example, the mechanism may copy the file if a link is not acceptable. In other instances, a solution might require creating a file that previously did not exist or changing a certain configuration or setting. It should be understood, accordingly, that exemplary embodiments are not limited to creating a link, and that the application can be enabled to run on the second operating system distribution in various ways without departing from exemplary embodiments. If successful, the user is prompted to hold the symbolic link or the other type of modification in a table for future reference. At the end of a run, the user may be asked if a script should be made to save all symbolic links for that particular application. Once the application is uninstalled, the user is asked if the system should be returned to its original state.

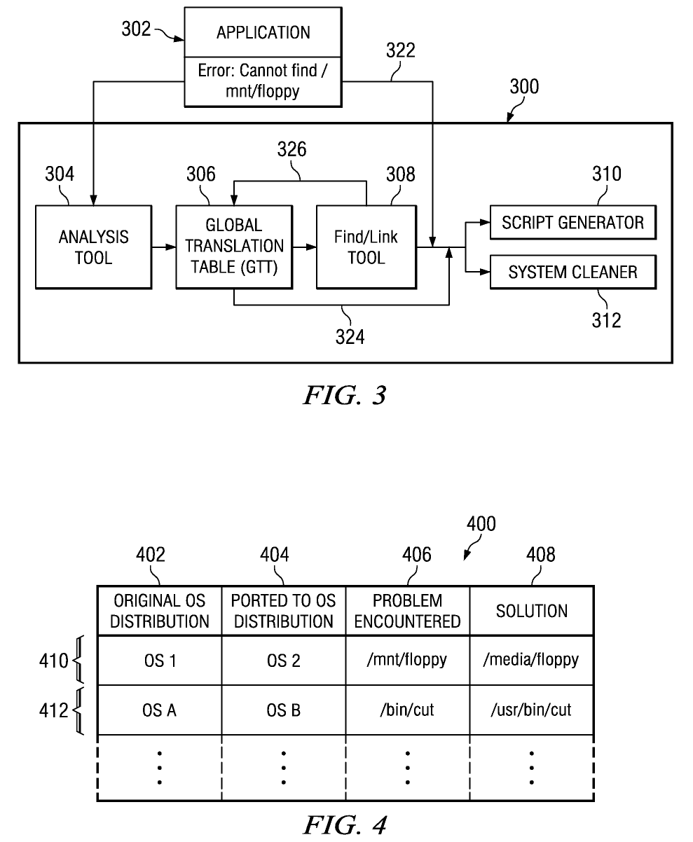

FIG. 3 is a block diagram that schematically illustrates a system for porting an application from a first operating system distribution to a second operating system distribution according to an exemplary embodiment. The system is generally designated by reference number 300, and includes analysis tool 304, global translation table (GTT) 306, find/link tool 308, script generator 310 and system cleaner 312.

Analysis tool 304 is responsible for analyzing the output of an application to be ported, for example, application 302 in FIG. 3. As illustrated in the figure, application 302 is an application that has encountered a problem when running on the second OS distribution. In the exemplary embodiment illustrated in FIG. 3 the encountered problem is “Error: cannot find /mnt/floppy.” It should be understood that this is intended to be exemplary only of problems that might be encountered, and it is not intended to limit exemplary embodiments to any particular problem. For example, other problems that might be encountered include missing environment variables; missing configuration options; and differently named executables, packages or files.

Analysis tool 304 identifies all the problems the application encounters when running on the second OS distribution and invokes find/link tool 308 with respect to each of the identified problems if solutions are not already available in GTT 306. Arrows 322 and 324 in FIG. 3 schematically illustrate this initial determination of available solutions to problems in GTT 306.

GTT 306 is a trainable unit that is modified as exemplary embodiments are run on multiple platforms. GTT 306 keeps track of solutions to problems that have been previously implemented. This is achieved, according to an exemplary embodiment, by providing a table-like format that contains the original and ported-to distribution, as well as the problem that was encountered and its solution. GTT 306 improves performance and usability by making it unnecessary to perform a find/link analysis each time an application is run. In addition, GTT 306 also decreases the amount of time necessary to port an application that has not been run previously from one distribution to another by holding various links in memory which might be needed by multiple applications.

FIG. 4 is a diagram that schematically illustrates a global translation table according to an exemplary embodiment. The table is generally designated by reference number 400, and can be implemented as GTT 306 in FIG. 3. As shown in FIG. 4, GTT 400 includes, with respect to each problem that is encountered by an application (although only two problems 410 and 412 are illustrated in FIG. 4, table 400 may contain any number of problems that are encountered), the original OS distribution 402, the ported to OS distribution 404 to which the application was ported to solve the problem, an identification of the problem encountered 406, and the solution to the encountered problem 408.

If not clearly identified within the application, the original OS the application was written for may be identified by prompting the user, however, this mechanism has the ability to identify the OS that the application is attempting to run on in the second OS by examining certain release information files. This information is used to identify the “original” and “ported to” distribution (items 402 and 404 in FIG. 4).

As one application is run on an OS distribution different from the one that it was intended for, various error or warning messages may be generated. These messages are appropriately parsed or shown to the user for further identification of the problem; this information will populate the “problem encountered” column (item 406) of the table in FIG. 4.

Once the cause is identified, and a solution is determined (for example, by creating a link, modifying a configuration or environment variable, disabling/enabling a service or a daemon, etc.), a description of the solution is populated in the “solution” column (item 408).

It should be recognized that the GTT need not always be in a table format. For example, the GTT may also be implemented as a text file, an XML file, a HTML file or in another suitable manner without departing from exemplary embodiments.

Returning to FIG. 3, find/link tool 308 performs the actual porting of the application by searching the new system and finding and creating links as needed. For example, assume application 302 is run on OS distribution A and encounters a problem of “Error: cannot find /mnt/floppy” as shown in FIG. 3. In such case, find/link tool 308 conducts a “find” operation on floppy. When floppy is found on the system as /media/floppy, a link with appropriate name “/mnt/floppy” is created. (As will be explained more fully hereinafter, the find operation and the link creation are preferably performed at the user's discretion). As shown by arrow 326, when a link is created, GTT 306 is updated with the new information for future use.

Script generator 310 allows the user to generate a script containing all the links and modifications that have been performed on the system. The script can be used independently of exemplary embodiments to create an environment for the application in the future.

System cleaner 312 is responsible for restoring the system to its original state, i.e., by removing all links that have been created.

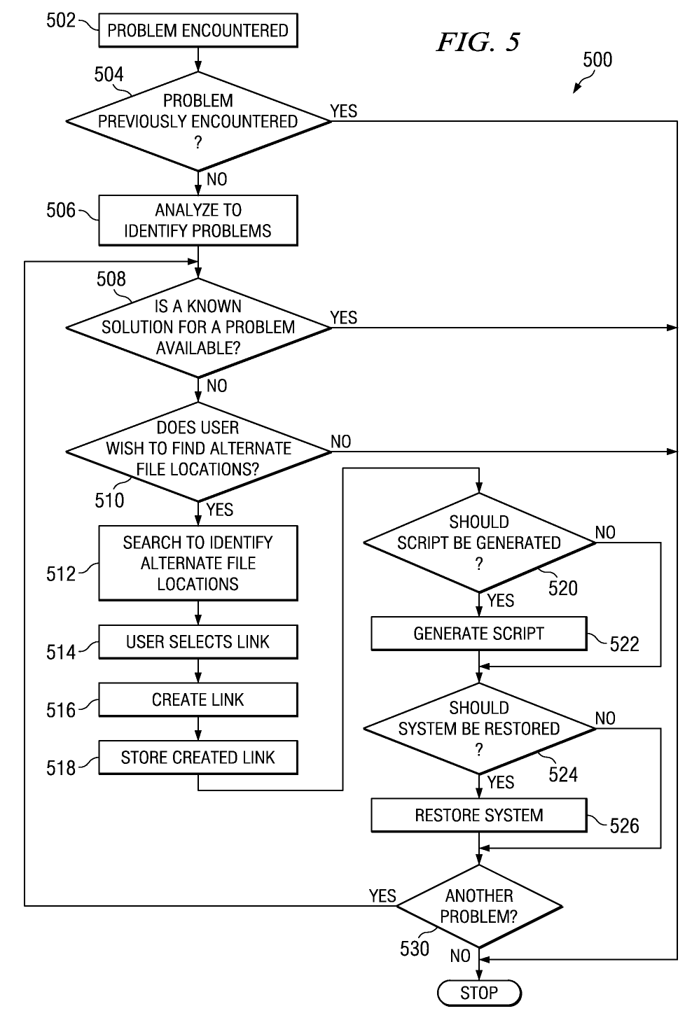

FIG. 5 is a flowchart that illustrates a method for porting an application from a first operating system distribution to a second operating system distribution according to an exemplary embodiment. The method is generally designated by reference number 500, and begins when an application intended for a first OS distribution encounters a problem when running on a second OS distribution, for example, a problem in finding a file location for the application (Step 502). A determination is made if the problem has been previously encountered by the same application or by a similar application that has previously been run (e.g., a different application having similar links to an application that has been run before (Step 504)). If the problem has not been previously encountered (No output of Step 504), the output of the application is analyzed to identify all problems the application encounters (Step 506). For each identified problem, a determination is made if a known solution is already available (Step 508). This determination is made, for example, by determining if the solutions are available in a global translation table (GTT).

If a known solution is not available (No output of Step 508), a determination is made whether the user wishes to find alternate file locations needed for the application (Step 510). If the user wishes to find alternate file locations (Yes output of Step 510), a search is conducted to identify alternate file locations which correspond most closely to the file on the OS distribution for which the application was originally intended (Step 512). When found on the system, a link with an appropriate name is created in the second OS distribution (Step 516) to enable the application to run on the second OS distribution. Alternatively, and as indicated previously, rather than creating a link, another modification such as modifying a configuration or environment variable, disabling/enabling a service or a daemon, and the like can be created to enable the application to run on the second OS distribution. If a plurality of alternate file locations is found, the user is prompted to select a desired one of the plurality of found file locations to which the link is to be created (Step 514) before the link is created. Information regarding the newly created link is then stored in the GTT for future reference (Step 518).

A determination is then made whether the user wishes a script to be generated containing all the links and modifications that have been performed (Step 520). Such a script can be used independently of the exemplary embodiments to create an environment for the application in the future, and the determination can be made by the user in response to a prompt requesting the user to indicate whether or not the script should be generated. If the user does not want a script to be generated (No output of Step 520), the method goes to Step 524 to determine if the system should be restored. If the user wishes a script to be generated, (Yes output of Step 520), the script is generated (Step 522), and the method goes to Step 524 to determine if the system should be restored.

The determination of whether the system should be restored to its original state in Step 524 can also be made by the user in response to a prompt. If the user decides that the system should not be restored (No output to Step 524, the method goes to Step 530 to determine if another problem has been identified. If the user indicates that the system should be restored (Yes output of Step 524), the system is restored, for example, by enabling a system cleaner to remove all created links (Step 526), and the method goes to Step 530. It should be understood that both the script generation and the system cleaning operations are optional, and may or may not be included in the overall method. If another problem is found (Yes output of Step 530), the method returns to Step 508 to determine if a solution is available for another problem.

Returning to Step 504, if the application is determined to be the same as or similar to an application that has previously been run (Yes output of Step 504), the method ends. Similarly, if it is determined that a solution to an identified problem is available (Yes output of Step 508), or that there are no more problems to be analyzed (No output to Step 530), the method also ends.

The exemplary embodiments thus provide a computer implemented method, system and computer usable program code for porting an application intended for a first operating system distribution to a second operating system distribution in a data processing system. A computer implemented method for porting an application intended for a first operating system distribution to a second operating system distribution in a data processing system includes identifying a problem when the application is run on the second operating system distribution. A determination is made if a known solution to the identified problem is available. If a known solution to the identified problem is not available, a search is conducted to identify a solution to the problem. At least one modification to the second operating system distribution is created according to the identified solution, wherein the application is enabled to run on the second operating system distribution.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for porting an application intended for a first operating system distribution to a second operating system distribution in a data processing system, the computer implemented method comprising:
identifying a problem when the application is run on the second operating system distribution;
determining if a known solution to the identified problem is available;
if a known solution to the identified problem is not available, searching to identify a solution to the problem; and
creating at least one modification to the second operating system distribution according to the identified solution, wherein the application is enabled to run on the second operating system distribution.

2. The computer implemented method according to claim 1, wherein determining if a known solution to the identified problem is available, comprises:
determining if a known solution is stored among a plurality of stored known solutions to problems that have been encountered.

3. The computer implemented method according to claim 2, wherein determining if a known solution is stored among a plurality of stored known solutions to problems that have been encountered, comprises:
determining if a known solution is stored in a table of known solutions to problems that have been encountered, wherein the table includes with respect to each problem that has been encountered, identification of the first operating system distribution, identification of the second operating system distribution, identification of the encountered problem, and identification of a known solution to the encountered problem.

4. The computer implemented method according to claim 2, wherein the plurality of stored known solutions to problems that have been encountered is created using previous runs of the application.

5. The computer implemented method according to claim 2, and further comprising updating the plurality of stored known solutions to problems with a solution to a newly identified problem.

6. The computer implemented method according to claim 1, wherein, if a known solution to the identified problem is not available, searching to identify a solution to the problem comprises:
searching to find an alternate file location for the application in the second operating system distribution.

7. The computer implemented method according to claim 1, and further comprising:
receiving user input requesting the searching to identify a solution to the problem.

8. The computer implemented method according to claim 1, and further comprising:
receiving user input requesting creating at least one modification to the second operating system distribution according to the identified solution.

9. The computer implemented method according to claim 1, wherein creating at least one modification to the second operating system distribution according to the identified solution, comprises:
creating a link to the identified solution in the second operating system distribution.

10. The computer implemented method according to claim 1, and further comprising:
generating a script containing modifications that have been created.

11. The computer implemented method according to claim 1, and further comprising:
restoring the second operating system distribution to its original state by removing modifications that have been created.

12. A computer program product, comprising:
a computer usable medium having computer usable program code configured for porting an application intended for a first operating system distribution to a second operating system distribution in a data processing system, the computer program product comprising:
computer usable program code configured for identifying a problem when the application is run on the second operating system distribution;
computer usable program code configured for determining if a known solution to the identified problem is available;
if a known solution to the identified problem is not available, computer usable program code configured for searching to identify a solution to the problem; and
computer usable program code configured for creating at least one modification to the second operating system distribution according to the identified solution, wherein the application is enabled to run on the second operating system distribution.

13. The computer program product according to claim 12, wherein the computer usable program code configured for determining if a known solution to the identified problem is available, comprises:
computer usable program code configured for determining if a known solution is stored among a plurality of stored known solutions to problems that have been encountered.

14. The computer program product according to claim 12, wherein, if a known solution to the identified problem is not available, the computer usable program code configured for searching to identify a solution to the problem comprises:
computer usable program code configured for searching to find an alternate file location for the application in the second operating system distribution.

15. The computer program product according to claim 12, and further comprising at least one of:
computer usable program code configured for receiving user input requesting the searching to identify a solution to the problem; and
computer usable program code configured for receiving user input requesting creating at least one modification to the second operating system distribution according to the identified solution.

16. The computer program product according to claim 12, wherein the computer usable program code configured for creating at least one modification to the second operating system distribution according to the identified solution, comprises:
computer usable program code configured for creating a link to the identified solution in the second operating system distribution.

17. The computer program product according to claim 12, and further comprising at least one of:
computer usable program code configured for generating a script containing modifications that have been created; and
computer usable program code configured for restoring the second operating system distribution to its original state by removing modifications that have been created.

18. A system for porting an application intended for a first operating system distribution to a second operating system distribution in a data processing system, comprising:
a mechanism for identifying a problem when the application is run on the second operating system distribution;
a mechanism for determining if a known solution to the identified problem is available;
if a known solution to the identified problem is not available, a mechanism for searching to identify a solution to the problem; and
a mechanism for creating at least one modification to the second operating system distribution according to the identified solution, wherein the application is enabled to run on the second operating system distribution.

19. The system according to claim 18, wherein the mechanism for determining if a known solution to the identified problem is available, comprises:
a table storing solutions to problems that have been encountered.

20. The system according to claim 18, wherein the mechanism for creating at least one modification to the second operating system distribution according to the identified solution, comprises:
a mechanism for creating a link to an alternate file location in the second operating system distribution.
